(19) United States
(12) Patent Application Publication
(10) Pub. No.: US 2022/0251424 A1
(43) Pub. Date: Aug. 11, 2022

(54) METHOD FOR RECONFIGURING A MUSICAL INSTRUMENT, AND ASSOCIATED STICKER

(71) Applicant: Aymeric Dahl, Marly Le Roy (FR)

(72) Inventor: Aymeric Dahl, Marly Le Roy (FR)

(21) Appl. No.: 17/619,234

(22) PCT Filed: Jun. 14, 2020
(86) PCT No.: PCT/IB2020/055556

§ 371 Date: Dec. 14, 2021

(30) Foreign Application Priority Data
Jun. 14, 2019 (FR) FR1906389

(51) Int. Cl. C09J 7/25

(52) U.S. Cl. CPC C09J 7/25; C09J 2203/37; C09J 2301/31; C09J 2301/302; C09J 2483/00

(57) ABSTRACT

The invention concerns a method for reconfiguring a musical instrument. The method includes a step of applying a sticker on at least one technical surface of the musical instrument, characterized in that this application is made without glue and in that the sticker comprises an elastomer layer configured to come into contact with the technical surface and adhere to it in a reversible manner without application of glue. The invention further concerns a sticker and an associated manufacturing method.

The present invention relates to the field of reconfiguration of musical instruments. In this context, reconfiguration is understood as including in particular decoration or personalization (customization) by means of themes, visual effects and textures; visual aids to musical learning, for example by note names or symbols; or as the establishment of a communication and/or promotion medium.

More particularly, the invention relates to the application of one or more stickers for the purpose of reconfiguring musical instruments.

The state of the art offers stickers, but their use in the reconfiguration of musical instruments is not entirely satisfactory.

Musical instruments generally have a plurality of technical surfaces. These are in particular surfaces whose vibration makes it possible to restore the sound of the instrument, delicate and fragile surfaces, and/or surfaces made of a living-type material needing to “breathe”, namely to be traversed by air, so as not to deteriorate quickly. Some technical surfaces have fragile coatings or varnish which makes it difficult to use stickers.

The use of stickers with glue is problematic in that glue residues permanently clog the pores of technical surfaces or deteriorate the coatings thereof.

In addition, the use of commercial stickers alters the sound of the technical surface covered.

In addition, for certain technical surfaces, it is important that the sticker covers the surface aesthetically, including in relief.

Furthermore, commercial stickers have several other drawbacks.

Some stickers have a stiff, preferably mono-component, polymeric structure, and with a rather dry and sticky viscoelasticity only on a very clean and smooth surface, which results in air bubbles in use. Many of them do not stick to a surface that is not completely clean, and fear heat and poor storage (compared to the timely unlimited advantage of the invention) which generates irreversible wrinkles. The rigid side prevents application to convolutive surfaces (because it is deformable and not stretchable) and almost completely decreases adhesion on surfaces from a slightly dirty or dusty state.

In addition, some stickers have a micro-perforated adhesive structure or with micro-voids or multi-holes with a suction effect adhering by suction allowing adhesion on smooth to slightly less smooth supports, but they are very sensitive to dirt and dust quickly sticking to it. Also, this feature reveals a non-shiny finished surface with a hammered effect that eludes aesthetic finishing of the product. In addition, this material is not stretchable and is sensitive to tearing. Finally, this same material leaves when touched an unpleasant sticky feeling and strongly affects the absorption of fat and dust.

Other stickers have a multi-layered polypropylene film structure with micro-voids such that in use, some do not hold but slide across the surface. Others do not accept matte and porous surfaces. The rigid side prevents application on convolutive surfaces (the product being deformable in stretch and not basically stretchable). The smoothness of the product removes the possibilities of volume, 3-dimensional effect and textures. Also, when peeling for removal, the parts that are lifted first suffer from the lifting action. Between the force exerted during lifting, the adhesion of the sticker to the substrate and the fineness of the product, the deformability of the material of the sticker is unfortunately still present.

Other stickers have adhesion based on electrostatic or vitrostatic forces, and need water and marouflage to be applied, which is tedious. In addition, they are also deformable and non-stretchable, in particular by virtue of their rigidity and fineness. The lack of volumes has a direct impact on the impossibility of producing different volumes and textures on the surface.

A first objective of the present invention is to provide reconfiguration means removing the permanent obstruction of the pores of the technical surfaces of musical instruments, and/or preserving the coatings thereof.

A second objective is to provide reconfiguration means which alter less the sonorities of technical surfaces, or reconfigure sonorities in a specific manner.

A third objective is to be able to aesthetically cover the reliefs of the technical surfaces.

A fourth objective is to provide an unlimited reusable means.

To achieve these objectives, the invention provides a method for reconfiguring a musical instrument, comprising a step of applying a sticker on at least one technical surface of the musical instrument.

According to a first aspect, the application is made without glue, and the sticker comprises an elastomer layer configured to come into contact with said technical surface and to adhere to it in a reversible manner without application of glue. In particular, the sticker is configured to be applied to at least one technical surface of a musical instrument to reconfigure the musical instrument.

Advantageously, the application of the sticker without glue makes it possible to limit the permanent obstruction of the pores of technical surfaces of musical instruments, and to preserve the coatings thereof.

In addition, the sticker can be applied reversibly, that is, it can be removed to clean the surface of the instrument or to let it breathe.

In addition, the sticker is sufficiently elastic to allow vibrations of technical surfaces so that the sounds are less altered, in particular with the preservation of the varnish. Moreover, it is possible to configure one or more specific stickers modifying the sonorities on purpose, in particular for more experienced musicians (developed ear).

This is for example a set of stickers (with possible design) on the body of the instrument, for the search for a different sound, for example more muffled, soft and round, with several declensions of thickness (0.5 to 2 mm thick, 2 mm being the thickness to have the most muffled and round sound) and of size to specify this playing, also according to the dimension of the body or the bell of the instrument.

The viscoelasticity of the sticker enables it to be stretched to aesthetically fit and conform to the reliefs and contours of the technical surface.

Preferably, the method comprises a stretching step during the placement of the sticker.

The stretchability and adhesion power enables the application of the sticker with ease and without air bubbles between the technical surface and itself.

Preferably, the invention has as a declension, a minimum of 2 types of product format.
a first offering a product type format a) in the form of an A5/A4/A3 sheet and others . . . , free to be created: cutable and adaptive.
a second product type format b) in the form of a ready-to-use sticker, previously styled.

Preferably, the method comprises a cutting step before or after the application of the sticker.

The invention further relates to a sticker for reconfiguring a musical instrument, characterized in that it comprises an elastomer layer configured to come into contact with at least one technical surface of the musical instrument, and reversibly adhere to it without applying glue.

This is in particular a sticker for a reconfiguration process according to the invention.

According to other aspects taken alone or combined in all technically feasible combinations:
the elastomer layer comprises at least one elastomer chosen from silicone; an alginate; natural or synthetic rubber; natural or synthetic latex; neoprene; polyurethane; nitrile; EPDM; Butyl (Polyisobutylene); mastic, chlorosulfonated polyethylene; parablond; fluorocarbon rubber; and/or
the elastomer layer comprises RTV Polyaddition silicone; and/or
the sticker comprises an association of several adjoined structures; and/or
the sticker comprises a complex three-dimensional configuration, in particular by reliefs and/or associated textures.

The invention further relates to a method of manufacturing a sticker, comprising the steps for:
preparing at least one elastomer composition;
applying the composition to a sticker forming medium

characterized in that the application is by pressure and/or squeegee on at least one sticker mold surrounding said elastomer composition.

Preferably, several structures are made using one or more elastomeric compositions, applied using one or more sticker molds.

The invention also relates to a use of a sticker according to the invention as a visual aid for musical learning.

The invention will be further detailed by the description of non-limiting embodiments, and on the basis of the appended figures illustrating preferred embodiments of the invention, in which:

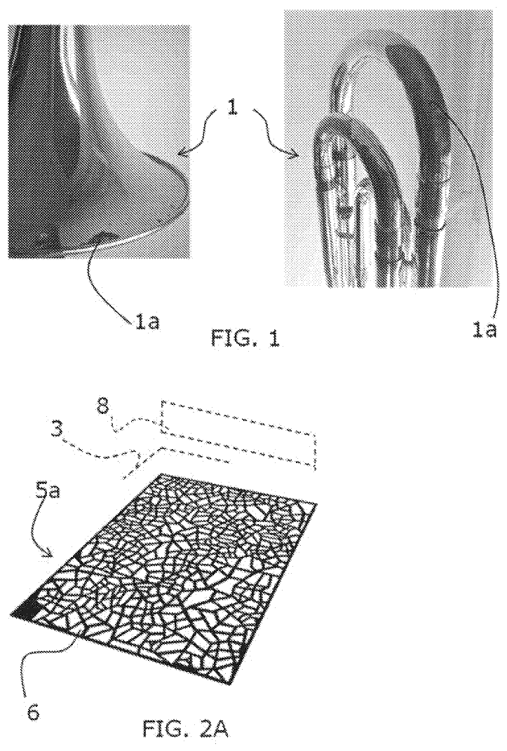

FIG. 1 illustrates wear deterioration on a technical surface of an instrument of the wind family (here the brass), the trombone;

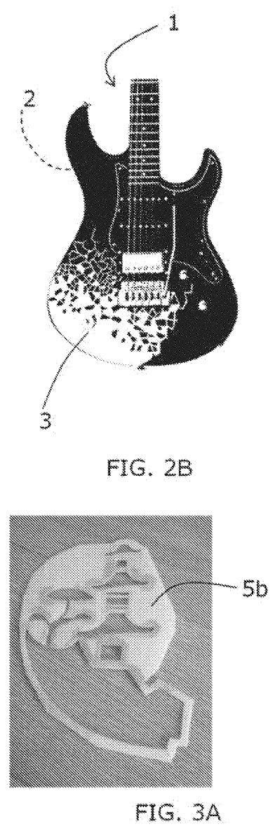

FIG. 2A is a space view of a board for making a sticker by a method according to a first embodiment (product type a), and applied to a guitar;

FIG. 2B is a plan view of a guitar having a sticker obtained by means of the board of FIG. 2A;

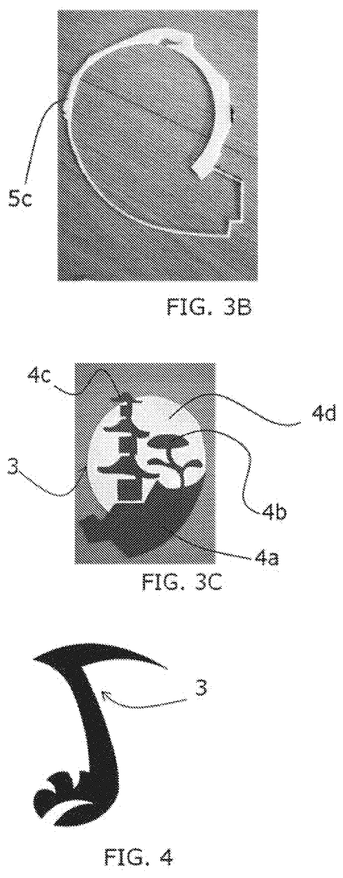

FIG. 3A is a plan view of a first mold for producing a first part of a sticker by a method according to, depending on the choice, a second or a third embodiment with, as an option of the third embodiment, a relief in background to be added (relief not present in the figure), (and this for formats and types of product a) or b)),

FIG. 3B is a plan view of a second mold for making a second part of a sticker in addition to the part of FIG. 3A;

FIG. 3C is a plan view of a sticker taken from the parts corresponding to FIGS. 3A and 3B in the third embodiment (presence of reliefs);

FIG. 3D is a close space view of parts of stickers obtained by a method according to a third embodiment (central sticker and on the right), in comparison with a sticker obtained according to the second embodiment (on the left);

FIG. 4 is a plan view of a sticker made according to the first embodiment for another type of product (product type b);

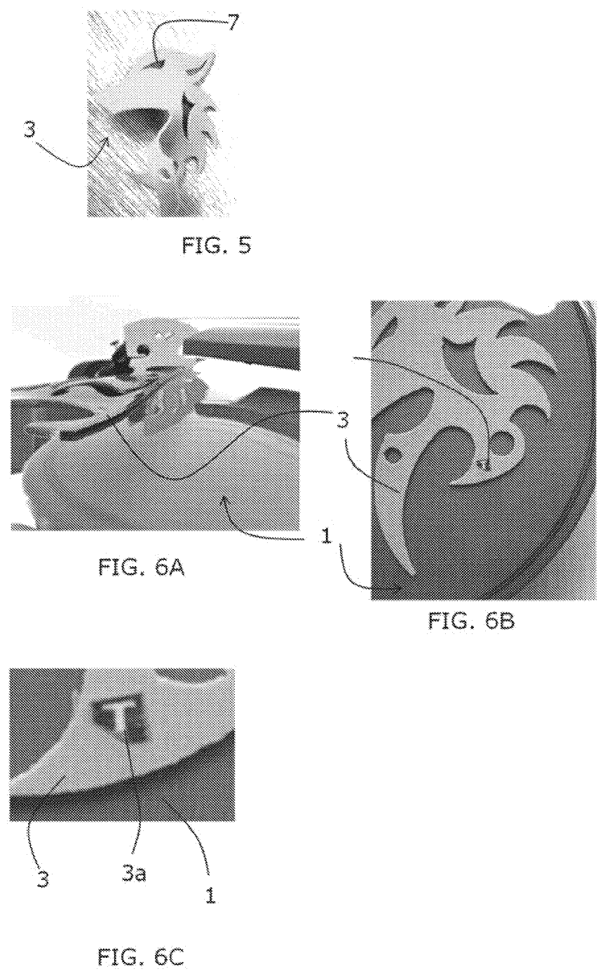

FIG. 5 is a plan view of another sticker made according to the first embodiment, obtained by means of another mold; under product type b).

FIGS. 6A and 6B are space views of further stickers made according to the first embodiment, on stringed instruments such as violins; and

FIG. 6C is a close plan view of a detail of the sticker of FIG. 6B;

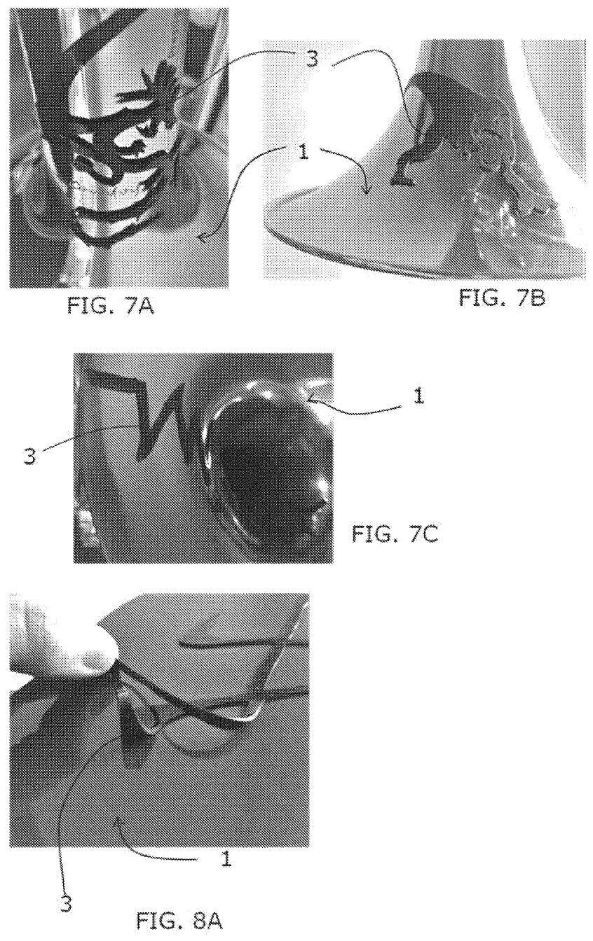

FIGS. 7A to 7C are space views of other stickers made according to the first embodiment, on brass instruments, here trombones; under product type b).

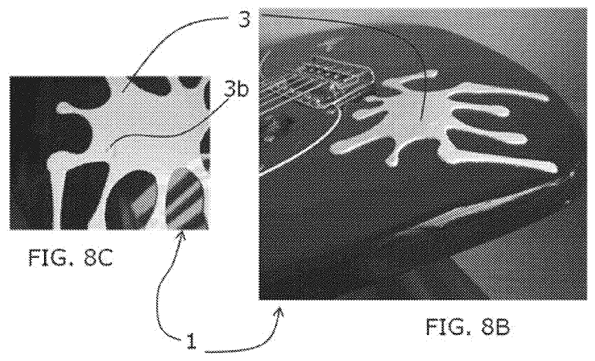

FIGS. 8A and 8B are space views of other stickers made according to the first embodiment, on guitars; and

FIG. 8C is a close plan view of a detail of the sticker of FIG. 8B.

The invention relates to the reconfiguration of musical instruments 1. In the context of the present file, it is in particular the decoration or personalization (customization) of musical instruments 1.

The personalization of musical instruments is not really practiced. The French and global musical worlds offer no satisfactory customization/personalization to the user to unleash their creativity, enhance their instrument, define themselves, find their world and motivate themselves through it.

The reconfiguration within the scope of the invention is done, for example, by means of themes, visual effects and textures; or as a communication and/or promotional medium. The promotion can for example be a promotion of a musical group or a brand, in particular the presentation of a logo, a name, a slogan, a price . . . .

The processes will be further detailed below.

The reconfiguration can also enable one or more stickers to be used as a visual aid to musical learning, for example by note names or symbols.

The inscriptions can be made by printing (in particular by superposition) or inlay (in particular by molding).

Some stickers on the market are not suitable for musical instruments with technical surfaces 2 because they have glue.

By “technical surface” is meant in particular surfaces whose vibration makes it possible to restore the sound of the instrument, delicate and fragile surfaces, and/or surfaces made of living material, such as wood (or metals), needing to “breathe” i.e., to be traversed by air, so as not to deteriorate rapidly.

Indeed, the instruments need to be in good hygrometric and thermal condition to be stored. Thus, the air must be healthy to best conserve the materials of the instruments. A sticker that is remains applied or has left glue will affect the non-passage of healthy air and will accelerate aging. Hence the advantage of the unlimited removal of the non-disposable silicone sticker. In addition, varnishes become more and more fragile and less resistant over time, they peel off easily and the removal of stickers with glue will automatically cause its removal.

As can be seen in FIG. 1, we see the aggression by the touch of the musician but also of the air over time which caused the flaking of the varnish and the implementation of the defense of the material (here, wear 1a by oxidation, verdigris and peeling of the varnish). Some technical surfaces have fragile coatings or varnish or lacquer that complicates the use of stickers.

Musical instruments, being either rented or purchased, present an emotional and financial aspect to the musician. Products with glue are really not suitable for these conditions.

Indeed, the glue is problematic in that glue residues permanently block the pores of technical surfaces 2 of musical instruments 1 or deteriorate the coatings thereof.

In addition, commercial stickers are significantly rigid, which alters the sonorities of the technical surface 2 covered.

Moreover, certain technical surfaces 2 may have convolutions (curves and shapes), or positive or negative reliefs. It is important that the sticker covers surface 2 aesthetically, including in reliefs and on convolutions, avoiding folds.

In an embodiment, a specific configuration of the sticker design also helps adhesion on the more complex, convolutive and large shapes. The strategy is to make void zones to aid in surface adhesion in contact, decreasing the tension in the silicone material as it has less solid material. This results in easier stretching. For example, an A4 size silicone mashrabiya will be more stretchable than an A4 sheet of (full) silicone of the same thickness.

More particularly, the invention proposes to apply new stickers 3 for the purpose of reconfiguring musical instruments 1.

Thus, the invention relates to a process for reconfiguring a musical instrument 1, which may be those composing a symphonic or philharmonic orchestra such as a guitar, a piano (body and/or keys), a violin, a trumpet, etc.

The method preferably comprises a step of preparing the technical surface 2 to be reconfigured. This is in particular a cleaning of said surface 2 to remove dust residues, for example.

The method according to the invention comprises a step of applying one or more stickers 3 to at least one technical surface 2 of the musical instrument 1.

Instruments 1 are for some “alive and breathing”. Wood or metals need a specific varnish (nitrocellulose, polyurethane, polyester, etc.) or a protective lacquer that lets them “breathe” so as not to age prematurely and also allow sound to be transmitted to perfection.

The role of varnish covers 3 aspects: resistance, aesthetics and sonority.

It is preferred to provide a deformable and shape memory sticker 3. In the preferred embodiment, the sticker is both deformable and shape memory under all thermal conditions acceptable for the instrument, in particular from −20° to +150° C., and probably even more normally. In addition, the sticker is very resistant to sudden changes in temperature.

It is also important that the sticker has good adhesion to avoid peeling, especially at the ends of the sticker.

Sticker 3 fulfills all these purposes and enables to customize instrument 1 without depositing or penetrating glue and solvent on the materials, and moreover, they do not distort the hearing.

Thus, according to the invention, the application of said sticker 3 is done without glue. Thus, the application of the sticker does not induce a sticky residue clogging the pores of technical surfaces 2 or damaging delicate technical surfaces 2. This results in better preservation of technical surfaces 2.

In addition, the sticker 3 comprises an elastomer layer configured to come into contact with said technical surface 2 and to adhere to it in a reversible manner without the application of glue.

Advantageously, said sticker can be applied reversibly, can be removed to clean the surface 2 of the instrument 1 or to let it breathe. This can be illustrated by FIG. 8A.

In addition, the sticker 3 has sufficient residual elasticity to allow vibrations of technical surfaces 2 so that the sonorities are less altered while optimizing its hold when the sound is emitted.

Furthermore, said sticker can be stretched so as to make it aesthetically match the reliefs of the technical surface 2.

Thus, according to an embodiment, the method further comprises a stretching step during the placement of the sticker 3. This step makes it possible to fit and conform the positive or negative convolutions and reliefs of the technical surface 2. This can be illustrated by FIG. 6A to 7C.

Advantageously, the invention enables both stretching, unlimited repositioning, cleaning, change of design, 3d aspects (relief, textures, etc.), light-reflecting, phosphorescent effects, pastings, overlays and stacking, a possibility of writing or drawing on it . . . and a thicker and more qualitative product to the touch and with respect to wear.

Stretching may not be necessary, especially for substantially flat engineered surfaces. For curved surfaces stretching may be necessary.

According to an embodiment, the method further comprises a cutting step preferably before the application of the sticker.

In this embodiment, a sticker greater than the technical surface 2 to be covered can be produced and applied. The excess sticker 3 can be cut off Instrument 1 obtained has complete and aesthetic coverage. This aspect can be illustrated by FIG. 2B.

In particular, it is a cutting using a tool such as scissors or a cutter with reference to a felt-tip or marker/pencil tracing specifically designed so that the tracing is erasable using a specific cleaning kit.

Tracing can be done on the instrument. The resistance of the silicone will not force the pencil tip into the material of the instrument. The cutting of sticker 3 is preferably done outside the instrument.

Cutting can be done for large format boards. It is preferably not needed for already drawn and finished designs, such as the wolf s head (FIG. 5), or the eighth note (FIG. 4), or the Japanese landscape (FIG. 3C). These can be made in different sizes ready to use for all instruments. In general, we will refer to them as product format and type b) for these stickers; and product format and type a) for cut-out stickers such as those in FIGS. 2A and 2B.

The invention further relates to a sticker 3 for reconfiguring a musical instrument 1. This is in particular a sticker perfectly configured for implementation for a reconfiguration method as described above.

According to the invention, the sticker 3 comprises an elastomeric layer configured to contact at least one technical surface 2 of the musical instrument 1. The sticker 3 is preferably an elastomeric sticker. In addition, the elastomer layer is configured to adhere to the engineered surface 2 reversibly without the application of glue.

More particularly, the elastomer layer does not include glue or any other substance likely to leave sticky residues after removal of the sticker 3. More particularly, the elastomer layer is not used with this type of glue or substance.

Preferably, the sticker 3, in particular the elastomer layer, is configured to have an extremely smooth surface. The layer is for example the result of a specific molding sought to achieve this non-slip texture generating a high coefficient of friction that can hold vertically and even upside down (towards the ground).

The sticker depending on the preferred embodiment has good performance under standard outdoor climatic conditions (wind, rain, etc.), as well as on oily or dusty instruments.

In a preferred embodiment, the basic principle of the sticker 3 is to make it on at least one of its surfaces completely smooth, enabling it to adhere to any support of the same zero roughness, such as varnishes or lacquers on instruments 1 that are wooden, metallic or in plastics . . . .

The sticker 3 allows a perfect adhesion by fitting and conforming to the shapes (by its elasticity) in particular by simple pressure of the sticker with the fingers on the receptive surface, leaves no trace of glue (because there is none), and lets an easy pasting and taking off without resistance, always with the hands.

Sticker 3 does not damage the varnish of musical instruments 1 and other fragile surfaces 2 that can be decorated or applied with a sticker.

A pasting is more effective with a clean sticker. It is washable with water for dust removal and with a cleaning solution for grease removal. Drying can be done in the open air or with a cloth (microfiber) that does not deposit any fiber to gain adhesion efficiency.

In an embodiment, the structure of the sticker includes a glue-free elastomer with elasticity that limits air bubbles in use. The possible finesse of the finished product (less than half a millimeter) offers visually, practically no relief and a particular choice of aesthetics (ultra-flat). The use of the instrument with the sticker is also facilitated by the non-relief and the exceptional adhesion to the substrate (varnish, lacquering, etc. of the instruments). This feature offers a very adhesive bonding on a clean surface, in particular through the very low weight of the sticker and the origin of the material having a viscoelasticity ratio targeted mainly on strong adhesion rather than elasticity. Repositioning remains unlimited if no deformation applies. Cleaning with water is still possible. In addition, for a volumetric effect or with different textures, gluing on the product can be done in order to add volume in superposition. Preferably, this extra thickness function requires the added part to have the same elasticity as the lower part. If the presence of an adhesive (glue) is to be applied, it should be contained only on the surface bonding them. Thus, the product will become a multilayer with volume and the basic advantages of this embodiment.

Furthermore, unlike certain commercial stickers, the sticker according to another embodiment of the invention includes an elastomer chosen to enable adhesion without adhesive significantly on very clean surfaces, and being stable at usual temperatures. This second embodiment, by the design of multilayers of polymer films with vacuum, makes it possible to have a sticker that is positioned almost automatically by its approach on the substrate while being sucked into it. The non-stretchable and rather rigid side of the product offers the advantage of virtually no appearance of bubbles and the removal of these by simply passing the hand from the center of the sticker outwards.

Again, thanks to its rigid hold, the application becomes easier to implement by applying it with hold and keeping the shape of the design on the entire sticker. Adhesion lasts as long as no peeling is done. The removal is done without force with just peeling off one corner of the sticker with the tip of a fingernail. Repositioning remains unlimited if no deformation applies. Cleaning with water is still possible.

Finally, the musician's playing is made easier by the finesse of the product, which avoids any snagging during movement. In addition, for a volumetric effect or with different textures, gluing on the product can be done in order to add volume in superposition. This method requires the added part to have the same elasticity as the lower part. It should be contained only on the surface connecting them. Thus, the product will become a multilayer with volume and the basic advantages of this embodiment.

In addition, unlike some commercially available stickers, the sticker of the invention includes an elastomer to provide grip and prevent slipping.

Another embodiment with a micro-perforated or multi-hole adhesive structure with a suction effect adhering by suction allows adhesion on smooth but also more difficult substrates such as: on slightly porous, rough, matt, little dusty, little greasy and used, matt varnishes, instruments frosted or without varnish. This material maintains thickness and can be molded to effect shapes and textures.

Moreover, an additional element can also be added to it by gluing on its surface. The material accepts wet cleaning allowing the product to be refurbished. The flexibility of the material offers application on convolutive surfaces. An ideal viscoelasticity ratio is to be put in place in order to maintain the main objective of the very sticky property of the sticker on so-called difficult surfaces, and the elasticity for application on technical convolutive surfaces. In addition, it also retains the property of not sticking with glue.

According to an embodiment, the elastomer layer comprises silicone.

The silicone sticker 3 is capable of being used for various solutions: It can be a medium for advertising, information . . . because any pattern, text or design can be printed on it or molded and linked together.

According to an embodiment, the elastomer layer comprises RTV Polyaddition silicone. A silicone having the following properties is suitable for carrying out the invention and implements all the advantages listed in this application.

DOSAGE: mixture of base and catalyst of approximately 50% base and 50% catalyst.

Hardness (shore A): about 33 shA

Curing at 23° C.: about 2 h30-3 hours

Demolding: 3 h30

Coloring: Special silicone dye, preferably soluble in silicone oil;

Thinner: Silicone oil.

Release agent: EC release wax

Tensile breaking stress: 4.7 N/mm²

Elongation at break: about 430%

The sticker can have a given thickness to be chosen according to its size, in order to respect: its resistance to the instrument 1 in adhesion by its own mass (horizontal, vertical and upside down), its resistance to stretching, its respect for acoustics while keeping a thickness for the creation of relief and textures, its finesse for aesthetics, practicality for the playing, and stretching to suit all curved surfaces 2.

Below are typical thicknesses, to be distributed over an unlimited number of size scales:
Small size:

3 cm×5 cm=thickness from 1.0 mm to + or −100 μm
Medium size:

9 cm×15 cm=thickness from 1.1 mm to + or −100 μm
Big size:

20 cm×32 cm=thickness from 1.2 mm to + or −200 μm

The preferred thickness is between 1 and 1.5 mm with regularity of thickness.

Sticker 3, in particular in silicone, can be made with or without dye with a working time of up to 20 minutes. The sticker obtained can be transparent, monochrome, multi-color (which can be in gradation or by clear color transition), fluorescent, phosphorescent, glitter, covered with surface materials (e.g.: powder, foam and textile), fixed or encapsulated during polymerization or a combination of several of these visual aspects.

Encapsulation allows materials to be trapped in depth, in particular through their porous and clinging fibers and surfaces.

Thus, it is possible to provide additional inserts in the stickers and provide therein, for example, a mark, an image, a logo, etc., by creating a shape and color in silicone. This is, for example, encapsulation or negative printing.

Encapsulation can be done by printing (silicone or other material) in a cavity or directly on the flat surface of the sticker, then pouring the silicone over it closing it on the periphery and its surface. This type of encapsulation can be illustrated by FIG. 6C. The finished product is preferably not sensitive to the touch.

Negative printing can be done by molding made during casting. This can be illustrated by FIG. 8C.

Furthermore, the exterior/sensory aspect of the sticker obtained may have a glossy surface, mat surface, positive relief (s), negative relief (s), with empty areas, textures, or a combination of several of these aspects.

Advantageously, the desired viscosity, corresponding to a hardness (shore A) of approximately 33 shA, offers sufficient crushing power for daily and normal use of the sticker. This flexibility is sought after for its high adhesive and stretchable side. A range between 10 and 60 shA, preferably between 30 and 35 can be used.

The preferred tensile stress (about 4.7 N/mm²) provides sufficient tensile strength for everyday and normal use of the sticker for its application. In use, this limits the deterioration of the materials because no cracks in the material must be present so as not to generate its prolongation of tearing by traction. A range between 2 and 8 N/mm² can be used.

The preferred elongation at break of approximately 430% is ideal for overlaying all complex shapes of an instrument 1 to ensure adhesion. The rate may change depending on the thickness of the finished product and any additives added. An elongation of 100 to 800% can be used.

Preferably, a silicone allowing very high precision to reproduce the very fine details is chosen.

Also, the silicone chosen has a high stability, both dimensional and to aging over time.

In addition, silicone does not emit harmful particles on contact, or in volatile form.

The peel-off of the sticker according to the invention, in particular silicone-based, is carried out without leaving any visible trace (trace or deposit of glue, stain, deposit of fat, peel-off of varnish, etc.) on the substrate to which it adheres. The removal is rapid (thanks to a desired adhesive rupture ratio) without force and imposed peel angle and without damage to the surface. It induces respect for the varnish or lacquering of instrument 1 and also of the instrument itself.

The sticker according to the invention, in particular based on silicone, is stretchable for adaptation to any form of instrument 1 (on corrugated, curved surface 2), and stretchable and keeping the stretched position by simple contact with a pressure of the sticker on the receiving surface by its viscoelastic particularity.

Said sticker is non-deformable after stretching, returns to its initial shape after use, even when peeling off from the technical surface 2 with or without an object. In addition, this indeformability is valid for any small part or element of small thickness to the entire sticker.

In addition, the sticker according to the invention, in particular based on silicone, is protective, namely shock-absorbing (cushioning), and protects against perspiration, light/radiation, dust. It is heat resistant and does not retain dust significantly.

In addition, said sticker does not (or slightly) affect the sonorities of instrument 1 (small non-audible acoustic attenuation) with the desired finesse and creates a warmer, rounder and muffled sound.

It retains the aesthetics of reliefs, chamfers, angles and other textures (textures: mat, smooth, etc.), colors (strong, clear colors) and precise color transitions, and a very good ageing over time. It does not fade off.

Furthermore, the sticker according to the invention, in particular based on silicone, adheres even to the constraints of sound vibration and displacement movements of the musician or instrument 1. It can remain indefinitely in the desired location on the instrument and also when storing the instrument in its case or bag.

It is not deteriorated in poor storage, in terms of risk of kinking and deformation.

Alternatively or in combination, the elastomer layer can also comprise at least one elastomer chosen from another RTV silicone such as those for skin/or in food . . . ; silicone paste; an alginate; natural or synthetic rubber; natural or synthetic latex; neoprene; polyurethane; nitrile; EPDM; Butyl (Polyisobutylene); putty, chlorosulfonated polyethylene (CSM) or Hypalon™ (trademark of DuPont); parablond; fluorocarbon rubber or FKM (Viton™); or all silicon compounds (chemical compounds that contain silicon such as silicones and others . . . ). Of course, the layer may include a technically feasible copolymer of one or more of the elastomers listed herein.

The other embodiments of elastomers involve some or all of the advantages presented herein.

According to an embodiment, the sticker 3 comprises an association of several adjoined structures 4a-4d. This embodiment is made by means of one or the other manufacturing method described in the present invention. Advantageously, this makes it possible to produce stickers with different juxtaposed structures in order to have associated aesthetic effects. The material is preferably homogeneous in order to be able to bond the different structures, for example RTV silicone. This sticker 3 can be illustrated by FIG. 3C.

According to an embodiment, the sticker comprises a complex three-dimensional configuration, in particular by reliefs and/or associated textures. Advantageously, this makes it possible to produce stickers with complex structures in terms of reliefs, curves or shapes for more aesthetics. This sticker is implemented as before with different reliefs/textures on different molds 5b, 5c or mold parts 6, or by negative printing. The relief obtained can be illustrated by FIG. 8C.

The molds offer the possibility of applying relief elements to the base of the mold (technique and embodiment III detailed below) to make stickers in this way. Any “standard” mold may have the option of a relief or a texture by affixing an additional element in the background playing on the relief and the final aesthetic graphics. All mono-color casting solutions (mode): mode I (FIG. 8C and detail 3b) or multi-texture: mode III (FIG. 3D stickers in the center and on the right, and FIG. 3C) are valid for positive and negative textures or reliefs. The difficulty of the reliefs and choosing the average thickness for the sticker (between the thinnest and thickest layers of the sticker). Note: mode II, multi-color (FIG. 3D stickers on the left) can be modified if we add a relief in the background, so it will be transformed into mode III and embodiment II will no longer be used.

The invention further relates to a method of manufacturing a particular sticker 3. It is more particularly a process for manufacturing a sticker 3 as described above.

The method according to the invention comprises a step of preparing at least one elastomer composition. The elastomeric composition is in particular one of the compositions as described above.

The method further comprises a step of applying the elastomeric composition to an adhesive-forming support, for example made of glass, stainless steel, resin, etc.

According to the invention, the application of the elastomer composition is made by pressing and/or squeegee 8 on at least one sticker mold 5b, 5c, 6 surrounding said elastomer composition. The pressing or application of a squeegee is known per se. The invention provides new molds.

The invention also relates to a use of a sticker according to the invention as a visual aid for musical learning.

For example, we can provide stickers including note identifications, note names, chords, nuances . . . or combinations of these. The invention offers producing a removable marking that does not damage the technical surface.

In the case of using the instrument, it is preferable not to have a sticker in a place where the user plays the instrument, for example where the user touches the piano key several times. This makes it possible to avoid the removal of the sticker during the play and any “stopping” of the finger (by adhesion).

For example, during practice, the placement should be on the top of the keys, towards the piano and not towards the musician, in order to give free rein to the fingering play.

Making of the Sticker Mold:

A-Base of the Mold

The base can be smooth or mat, textured, or with a relief depending on the finished product chosen. A material like glass is very effective in having the desired grip and the glossy finish. In addition, the glass plate offers the visualization of air bubbles on the underside by transparency.

The lower part of the mold will be the visible part of the sticker.

However, a sticker with a smooth (non-mat) surface 2 on the visible side will have the particularity of being reversible and can be positioned on both sides on instrument 1.

B-Mold Outline

The mold 5b, 5c is for example made by a 3D printer (or other PVC or metal profile injection machine). The mold constitutes the peripheral rim serving as a container for the finished product for the casting of the sticker 3.

A mold postproduction step can be done by sanding over physical flaws during creation.

The part of the mold (in relief) obtained can be glued or welded (depending on the material) to the support, being here in glass.

Some parts may have insulated internal walls (such as islands) to create voids in the finished product or, for the insertion of a different finish color or texture (performed later). The mold for the sticker in FIG. 5 includes an island to form the eye 7.

Note: a mold formed in one go can also be made, comprising both the base and the outline. For this, before its realization, the expected finishes must be determined. Thus, the molding materials and the type of casting/injection/bending . . . will be chosen according to the expected finish.

C-Finishing the Mold

The mold is preferably extremely flat in order to particularly allow the squeegee 8 to pass. Thus, the silicone is spread uniformly, smoothly and over the same thickness. Casting and equalization can be done manually or robotically.

D-Silicone Casting

### 1st Embodiment

The first embodiment is similar to a one-shot casting with a finished product of the mono-finish/texture or mono-color type.

In a first preferred embodiment, a board 5a (product format/type a)) having several mold parts 6, is used. In other words, it is a set of several molds 6 joined together to make a large sticker. This embodiment can be illustrated by FIGS. 2A and 2B.

In essence, the first embodiment makes it possible to obtain a mono-color or mono-texture structure with or without parts 6, 7. It is made by direct casting.

FIG. 2A illustrates an A4 format sheet (product format/type a)) comprising a set of molds 6 joined together. The shape of the sticker is poured in one go on this mold composed of a base and 6 multi-islands which will provide voids when removing the finished board. The resulting sticker can be applied to a guitar such as the one shown in FIG. 2B.

Still with the 1st embodiment, the realization of the formats of product type b) follows the same method. See the stickers: 4, 5, 6A, 7A, 7B, 7C, 8A.

### 2nd Embodiment

In a second preferred embodiment, several molds 5b, 5c are used. This embodiment can be illustrated by FIGS. 3A to 3C.

In essence, the second embodiment makes it possible to obtain a multi-color structure. It is done by pouring in two stages, or even more. FIG. 3D sticker on the left.

In all cases, said mold is preferably 0.7 to 2 mm thick, more preferably 1 to 1.5 mm thick to have a desired sticker thickness.

To make a sticker with a minimum of 2 different colors, an elastomer composition of a first color must be poured (mold of FIG. 3A for example), then dried.

The first part of the sticker thus obtained is placed at least partially in a second mold, for example in the mold of FIG. 3B.

The second casting will be in the second mold, here larger than the first so that the new silicone freezes around the first product already on hold.

The fixing will therefore be successful.

For a third color, this method can be duplicated and so on.

### 3rd Embodiment

In a third preferred embodiment, to produce a sticker with a minimum of 2 different finishes, for example: mat and smooth or, in relief and smooth, the method is the same as the second. We can speak of a third embodiment during the application of texture thanks to the reliefs and/or textures at the bottom of the mold. In essence, the third embodiment achieves a multi-texture structure. Advantageously, this makes it possible to produce a sticker combining several complex structures. It is done by pouring in two stages, or even more. In particular, the smooth layer is poured first.

For a finish with at least a second surface other than smooth, the smooth surfaces of a drawing must be made first. This is because of the lack of adhesion of the non-smooth finished product against its production mold.

This method makes it possible to avoid, during the pouring of the second part of the product (part of the non-smooth surface), a lifting of the first part of the product. The principle of making the smooth part first, offers the use of its adhesion characteristic as a means of attachment to the base of the mold (glass) and thus prevents infiltration of the silicone from the second pour below. Thus, the casting of the non-smooth zone (s) can be done on the corresponding defined surface and bonded to the smooth product (zone) currently in place.

This technique can be applied with or without different colors.

This technique is preferably not applicable for stickers in mode 1: mono-finishes (fully matt or with fully positive or negative relief), because the latter can be poured all at once and therefore without risk of lifting.

As can be seen in FIG. 3D, the smooth texture shown on the left of the figure (mode I) differs from the 3D texture of the middle figure which includes a negative smoother relief. Likewise, these figures differ from the figure on the right which includes a matte texture that is more smooth texture.

An embodiment may be made the non-smooth multi-texture surfaces of the sticker. For this, the mold must be composed of a surface of texture x (not smooth) and adjacent to a minimum of texture y (smooth or not smooth) with a casting in one step. Thus, the result will be a sticker with one or more preferably non-smooth textures on its finished surface and having the possibility of being composed of adjacent non-smooth textures.

What is claimed is:

1-10. (canceled)

11. A method for reconfiguring a musical instrument, comprising a step of applying a sticker on at least one technical surface of the musical instrument, wherein the application is made without glue, and in that the sticker comprises an elastomer layer configured to come into contact with said technical surface and to adhere to it in a reversible manner without application of glue.

12. The method according to claim 11, comprising a stretching step during the placement of the sticker.

13. The method according to claim 11, comprising a cutting step before or after the application of the sticker.

14. The method according to claim 11, wherein the elastomer layer comprises at least one elastomer chosen from silicone, an alginate, natural or synthetic rubber, natural or synthetic latex, neoprene, polyurethane, nitrile, EPDM, Butyl (Polyisobutylene), mastic, chlorosulfonated polyethylene, parablond, and fluorocarbon rubber.

15. A sticker for reconfiguring a musical instrument, wherein the sticker comprises an elastomer layer configured to come into contact with at least one technical surface of the musical instrument, and reversibly adhere to the at least one technical surface without applying glue.

16. The sticker according to claim 15, wherein the elastomer layer comprises at least one elastomer chosen from silicone, an alginate, natural or synthetic rubber, natural or synthetic latex, neoprene, polyurethane, nitrile, EPDM, Butyl (Polyisobutylene), mastic, chlorosulfonated polyethylene, parablond, and fluorocarbon rubber.

17. The sticker according to claim 16, wherein the elastomer layer comprises RTV Polyaddition silicone.

18. The sticker according to claim 15, wherein the sticker comprises an association of several adjoined structures.

19. The sticker according to claim 15, wherein the sticker comprises a complex three-dimensional configuration, in particular by reliefs and/or associated textures.

20. The sticker according to claim 15, wherein the elastomer layer comprises at least one elastomer that is a silicone or a silicone derivative.

21. A method of manufacturing a sticker, the method comprising:
preparing at least one elastomer composition; and
applying the composition to a support for forming a sticker, wherein the application is made by pressure and/or a squeegee on at least one sticker mold surrounding said elastomer composition.

22. The method according to claim 21, wherein several structures are produced by means of one or more elastomer compositions, applied by means of one or more sticker molds.

23. The method according to claim 21, wherein the elastomer layer comprises at least one elastomer chosen from silicone, an alginate, natural or synthetic rubber, natural or synthetic latex, neoprene, polyurethane, nitrile, EPDM, Butyl (Polyisobutylene), mastic, chlorosulfonated polyethylene, parablond, and fluorocarbon rubber.

24. The method according to claim 21, wherein the elastomer layer comprises at least one elastomer that is a silicone or a silicone derivative.
